(19) United States
(12) Patent Application Publication
(10) Pub. No.: US 2021/0031459 A1
(43) Pub. Date: Feb. 4, 2021

(54) ADDITIVE MANUFACTURING DEVICE AND SYSTEM WITH AUTOMATED FAILURE RECOVERY AND/OR FAILURE AVOIDANCE UNIT

(71) Applicant: AddiFab ApS, Jyllinge (DK)

(72) Inventors: Jon Jessen, Veksø (DK); Peter Lund Sørensen, Vipperød (DK); Jan Madsen, Asnæs (DK)

(21) Appl. No.: 17/046,125

(22) PCT Filed: Apr. 11, 2019
(86) PCT No.: PCT/EP2019/059222

§ 371 Date: Oct. 8, 2020

(30) Foreign Application Priority Data
Apr. 11, 2018 (DK) PA 2018 70215

(51) Int. Cl. B29C 64/393; B29C 64/35; B29C 64/135; B33Y 30/00; B33Y 50/02

(52) U.S. Cl. CPC B29C 64/393; B29C 64/35; B33Y 50/02; B33Y 30/00; B29C 64/135

(57) ABSTRACT

An additive manufacturing device for additively manufacturing objects. The additive manufacturing device includes a build vat having a floor and configured to receive at least one build material. The build platform has a build surface for holding and/or supporting an additively manufactured object, a movement mechanism enabling moving the build platform into and out of the build vat, an energy source configured to provide energy to selectively solidify at least a part of the at least one build material in or from the build vat, and a debris elimination system for removing debris from the build vat. The debris elimination system includes a debris detection system configured to detect a presence of debris in the build vat, and/or a debris removal system configured to remove debris from the build vat once detected.

### FIELD OF THE INVENTION

The invention relates generally to an additive manufacturing device for manufacturing a product, wherein the additive manufacturing device comprises a failure recovery and/or failure avoidance unit that enables automated additive manufacturing.

### BACKGROUND

Additive manufacturing—also called 3D printing—has become an important product development tool. Rapid prototyping, iterative design, and concept validation are three disciplines that are considerably facilitated by 3D printers. Several different 3D printing platforms are commercially available in the market today, and each of these platforms have important characteristics and advantages that a product developer may exploit to create design models, demonstrators, functional prototypes, and small batches of components for product validation.

Many developments in relation to additive manufacturing aim at improving the capabilities towards mass manufacturing of products with more consistent quality between manufactured products, lower manufacturing costs pr. manufactured product, etc.

One trend aiming at bringing down the manufacturing costs pr. manufactured product involves increasing the level of automation offered to users of additive manufacturing. Increased levels of automation potentially allow higher levels of utilization with lower costs of staff, which will contribute to improved operating efficiencies. In addition, automation may support more robust processes and improved process output quality through quality assurance automation—see e.g. WO2016177894A1 that is incorporated in this application in its entirety.

Automated error detection is an important element in quality assurance automation for additive manufacturing as it allows faulty output to be identified before print jobs are finished or printed products are released. Early identification allows early interruption of faulty jobs, which may save materials and resources and prevent costly product recalls. It also allows manufacturers to step away from costly post-process performance verification to instead conduct quality assurance in-process.

Vision control and image analysis plays an important part in many automated error detection paradigms and is used extensively throughout the industry. The emerging automation of additive manufacturing has prompted the adaptation of vision control concepts used in other industries for use with additive manufacturing systems. For example, WO2017087451A1 discloses a system that applies optical image analysis to detect errors in individual layers of objects built by an additive manufacturing process based on selective laser sintering. US20150045928A1 applies a more holistic vision-based approach combined with computer analytics to interrupt an additive manufacturing process when an error is detected. Following interrupt, a second attempt at the same job may be started. Alternatively, the job may be skipped (e.g. to allow for failure mode analysis) and a new job started.

As is the case in most other industries, the error detection methodologies disclosed by prior art are aimed at ensuring that the quality of additively manufactured products complies with specifications. Accordingly, the object of analysis is the individual build and the objective is to identify errors in the components making up this individual build and to ensure that defective builds may be aborted as early as possible to avoid wasting time and material.

However, a first unresolved challenge associated with this approach is that errors that do not manifest in one or more of the components of a given build—but may cause build process problems—may not be detected. For instance, an error detection methodology that is based on inspection of each layer of a component as it is built (such as disclosed in WO2017087451A1) may fail to detect errors that manifest outside the layers. Such errors may for instance be related to loose component fragments resulting from a failed build or to gradual build-up of debris in a build zone. A similar problem is seen with error detection methodologies that are based on inspection of images of additively manufactured objects (such as disclosed in US20150045928A1), especially where the imaging of such objects is done while they are away from the build zone.

Furthermore, while the detection and subsequent abortion of a defective build job may prevent a waste of time and material, as well as release of defective products, it does not necessarily resolve the problem causing the defect. Detection also does not necessarily prepare the additive manufacturing system to resume operation.

Accordingly, in a system intended for automated manufacturing, it would be beneficial to have automated error detection that is followed by automated error resolution. The cyber-physical nature of additive manufacturing may often require that effective error resolution includes both suitable functionality of software and hardware.

Software functionality for performing automatic error resolution has been described in some literature and prior art. E.g. both WO2017087451A1 and US20150045928A1 describe various methods for iteratively improving the output from a given additive manufacturing process by using various types of automated failure mode analysis, machine learning, or similar. These methods typically involve the visual inspection of either entire components or individual layers as they are formed and are aimed at continuously improving the performance of the additive manufacturing system while driving down the number of iterations needed to achieve compliance with print job specifications.

While software for automatic error resolution has been disclosed by certain prior art, automatic physical error resolution has been less explored. A first challenge associated with physical error resolution in automated additive manufacturing is the technical diversity of additive manufacturing processes. Presently, the American Society for Testing and Material (ASTM) has identified seven different additive manufacturing technologies (see ASTM F2792-12a). However, one strategy that may be implemented to mitigate errors in one type of additive manufacturing processes may be useless when applied to a different type of additive manufacturing process. As an example, US20150045928 mentions an automated part removal by means of a blade that may remove failed objects from a build surface to prepare this build surface for a new job. While this strategy may be useful for additive manufacturing processes based on material extrusion onto a build zone, it may fail to adequately resolve errors occurring in a vat photopolymerization process.

In a vat photopolymerization process, liquid photopolymer in a vat is selectively cured by light-activated polymerization to create the desired components. Errors in a vat photopolymerization process will typically result in a need to remove partially or fully formed defective components from a build surface. This challenge is similar to the challenge resulting from an error in a material extrusion system and it may potentially be resolved by the same means.

However, errors may also often result in debris being left in the build vat. Such debris may not be removed by the means used to remove failed builds from a build surface and may cause multiple problems that will need to be automatically resolved to support automated operation of the vat photopolymerization system.

A first problem is that debris from a first failed build that is left in a build vat may come to contaminate one or more subsequent builds. Such contamination may be difficult to detect in the finished builds, especially where the debris is small and may come to negatively affect the performance and/or aesthetic quality of a product.

A second problem that is particular to systems having a light source placed below a build vat (so-called bottom projection stereo lithographic systems), where a build plane with a build surface is initially lowered to a distance one layer thickness above an (inner) surface of the build vat bottom, is that debris that is left in a build vat may be caught between the upper surface of the build vat bottom and the lower surface of the build plane. If the debris is relatively large, it may entirely prevent the build plane from being lowered to the desired initial position. But even debris that is small or compressible enough to let the build plane be lowered to the desired initial position may cause significant problems.

In bottom-up projection systems, build vats typically comprise non-stick foils or other membranes that allow separation of a polymerized layer from the bottom of the build vat after solidification. Such membranes are typically highly sensitive to surface damage and even minor damage (e.g. as a result of manually removing a piece of debris with tweezers or other manually operated tools) may significantly affect membrane performance.

### SUMMARY

It is an object to alleviate at least one or more of the above mentioned drawbacks at least to an extent.

Accordingly, it is a first debris removal objective, at least for some embodiments, to avoid having to remove large pieces of debris from the build vat using tweezers or other manually operated objects or tools. As substantial membrane damage may also result from even small debris being forced into such membranes by the build surface of a descending build plane, it is a second debris removal objective, at least for some embodiments, to ensure that even minor debris is removed from the build vat before a build starts. Thirdly, it is a further debris removal objective, at least for some embodiments, to facilitate prevention of debris being generated in the first place.

One aspect of the invention is defined in claim 1.

Accordingly, in one aspect of the present invention is provided an additive manufacturing device, preferably a bottom projection additive manufacturing device, for additively manufacturing objects, wherein the additive manufacturing device comprises
a build vat having a floor and configured to receive at least one build material (i.e. a material to form the object(s) to be manufactured through additive manufacturing),
a build platform having a build surface for holding and/or supporting at least one object being or having been additively manufactured,
an movement mechanism enabling moving the build platform into and out of the build vat (as well as moving the build platform inside the build vat),
an energy source configured to provide energy to selectively solidify at least a part of the at least one build material when contained in the build vat, and
a debris elimination system for removing debris from the build vat, the debris elimination system comprising
   a debris removal system configured to remove detected debris from the build vat.

In some embodiments, the additive manufacturing device further comprises a debris detection system configured to detect a presence of debris in the build vat.

In this way, a vat additive manufacturing device, and in particular a vat photopolymerization additive manufacturing device, is provided that is capable of automatically detecting and/or removing debris from a build vat before, during, or after a build thereby enabling continuous operation without operator intervention.

In embodiments without a debris detection system an option is simply to activate the debris removal system as disclosed herein at appropriate times whereby any debris present simply will be removed, e.g. after having additively manufacturing and removed relevant object(s) or at other times.

Some embodiments may also disclose a debris detection system as disclosed herein but no debris elimination system or a debris removal system—thereby only detecting debris prompting for manual action. However, such system will then not enable automatic handling of debris removal.

In some embodiments, the additive manufacturing device comprises a build vat with a build vat floor that is transparent to the passage of energy. In a subset of embodiments, a non-stick foil or a membrane is placed on an upper surface of the floor and prevents adhesion of additively manufactured objects to the build vat floor.

In a specific subset of embodiments, the non-stick foil is attached to the floor, whereas the foil is unattached in other embodiments. In some embodiments the foil is laying loosely on a supporting floor, and in yet some embodiments the foil is tensioned like a drum, and may be supported by a floor. In yet another subset of embodiments, the membrane is permeable, permitting the passage of a substance that prevents adhesion of additively manufactured objects to the floor. Other embodiments, may comprise other provisions or elements to prevent adhesion of parts to the build vat floor.

In some embodiments, the additive manufacturing device comprises a build platform that is configured to be lowered into—and elevated out of—the build vat in a direction that is perpendicular (or in another/other directions such as to the side, diagonally upwards, in a curved direction, etc.) to the build vat floor. Particular embodiments comprise build platforms that are vacuum-assisted. Yet more particular embodiments employ vacuum-assisted build platforms that are configured to permit the automated exchange of build plates. In some embodiments, build plates comprise a build surface that is optimized to promote adhesion (e.g. being rough, having grooves, indentations, vacuum-assistance, etc.) of additively manufactured objects.

In some embodiments, the additive manufacturing device comprises an energy source that promotes selective solidification of an energy-curable liquid that is placed in the build vat. In a particular set of embodiments, the energy applied is ultraviolet (UV) light, and the liquid is an UV curable resin. In a more particular set of embodiments, the energy source is a UV-DLP (UV digital light processor) or LCD (liquid crystal display) projector, whereas other embodiments are based on single-ray lasers. In a particular set of embodiments, the energy source is disposed below the build vat.

In some embodiments, the additive manufacturing device comprises a debris detection system that comprises one or more cameras. In a particular subset of embodiments, one or more cameras are disposed above the build vat whereas other embodiments comprise cameras disposed below the build vat. In yet other embodiments, cameras are disposed both above and below the build vat. Some embodiments employ cameras that have a fixed position whereas other embodiments employ cameras that are movable. A specific subset of embodiments employ cameras that are both movable and fixed in position.

A more specific subset of embodiments employ cameras that are polychromatic, whereas other embodiments employ monochromatic cameras. Where debris detection is based on the detection of edges or boundaries between areas containing debris and debris-free areas, monochromatic cameras are particularly advantageous due to their high contrast ratio. A particularly advantageous embodiment employs monochromatic cameras tuned to a target wavelength of about 530 nm, which are particularly beneficial when using an energy-curable liquid being a resin. Other types of energy-curable liquids could have other respective target wavelengths. Other embodiments employ cameras that are tuned to other target wavelengths, e.g. to enhance detection for energy-curable liquids having a specific colour. In some embodiments, filters may be applied to further reduce the inlet of light with wavelengths that differ from the target wavelength and further improve the signal/noise ratio.

A particularly advantageous subset of embodiments employ Canny filtering and associated algorithms to further enhance detection of edges or boundaries. A yet more advantageous embodiment employs Canny filtering for detection of voids (defined as areas devoid of edges or boundaries and having a size exceeding a predetermined threshold value) and where the presence of a void equates the presence of a piece of debris. Some embodiments employ binary classification of voids (above threshold or not), whereas other embodiments employ more granular classifications. Such classifications may in some embodiments be combined with debris location information to support monitoring of membrane health. Other embodiments combine void classification with information about object geometries to support statistical analysis, root cause analysis, failure mode analysis, or other types of analysis.

Some embodiments comprise cameras having resolutions of 5 megapixels, whereas other embodiments comprise cameras with lower or higher resolutions. Higher resolutions are particularly advantageous where the goal is to detect very small debris.

High resolution may also be advantageous where the goal is to avoid debris formation entirely. In some embodiments, such debris avoidance may be based on continuous monitoring of layer release patterns. Layer release is carried out when a layer has been solidified and the build platform is raised by the movement mechanism in preparation for solidification of the next layer and different additive manufacturing devices employ different layer release mechanisms. A particularly advantageous layer release mechanism is disclosed in WO2016177893A1 that is incorporated herein in its entirety. This mechanism employs a build vat floor deformation mechanism to generate a wave or slope that travels along the length of the floor of the build vat and effects a controlled and repeatable release of the additively manufactured objects from the build vat floor by peeling the floor away from the additively manufactured objects.

In some embodiments, the bottom of the vat is a foil attached to a flexible glass plate, rigid (but still flexible) polymer plate, or similar. In some alternative embodiments, a foil is tensioned like a drum between walls of the vat defining a cavity for containing the build material. The weight of the build material contained in the cavity (and the movement of the object during additive manufacture) will cause the foil to move up and down. Below the foil is placed a glass plate or similar (e.g. a flexible one) within a short distance, e.g. about 0.01 mm between them. Object(s) secured to the build plate will press the foil towards the glass plate providing a high contrast when the object(s) is raised for solidification of the subsequent layer causing the contrast to lessen or disappear. In some further embodiments, the distance may be larger, e.g. about 0.5 mm, where the object(s) are moved downwards towards to glass plate to provide a contrast and then subsequently raised up again.

In a preferred embodiment, this peeling happens in a controlled and gradual motion and may be imaged by a lower camera (a camera located under the vat) as a peeling pattern comprising gradual change in contrast or color in those areas where release has been achieved. A systematic monitoring of peeling pattern deviations may support failure mode detection and continuous improvements.

In some embodiments, deviations from a desired or expected peeling pattern may be caused by incorrect energy application from the energy source. Such deviations may signal excessive adhesion of a layer or part of a layer to the build vat floor, and a resulting application of excessive and/or uneven layer release force to individual objects or groups of objects. Such excessive force may, in turn, result in the generation of debris. If detected, they may be corrected by adjusting energy application, which may help to minimize or eliminate the risk of debris generation.

In other embodiments, deviations may be caused by a worn-out or damaged non-stick membrane. Yet other deviations may result from incorrect speed of deformation, whereas yet other deformations are caused by malfunctions in the energy-curable liquid. As each of these deviations may signal that excessive force is applied to an object or a group of objects, detection and correction of the failure mode or modes responsible for the deviation may contribute to the reduction or elimination of debris. Particular embodiments employ statistical analysis to compare a given peeling pattern with previous peeling patterns to detect deviations. More particular embodiments comprise a database that may be used to build a history of peeling patterns and peeling pattern deviations to support automated continuous improvement through the application of machine learning or other automated statistical analysis.

Some embodiments employ light sources to increase contrast and improve signal/noise ratios and support accurate detection of debris. In some of these embodiments, the light sources are LED light sources, whereas other embodiments employ other types of light sources. In a particular subset of embodiments, one or more LED light sources are disposed above the build vat, whereas other embodiments have LED lights that are disposed below the build vat. Some embodiments employ light sources that have a fixed position whereas other embodiments employ light sources that are movable. A specific subset of embodiments employ LED lights that are disposed both above and below the build vat. Other specific embodiments employ LED lights having specific wavelengths. In some embodiments, LEDs with an identical wavelength are used whereas other embodiments employ LEDs having different wavelengths. Some embodiments employ polychromatic LEDs whereas other employ LEDs that are monochromatic. Yet other embodiments employ LEDs that are both monochromatic and polychromatic.

A subset of embodiments have one or more LED lights that are either movably or fixedly disposed about the rim of the build vat, and are configured to illuminate the upper surface of the build vat and/or the energy-curable liquid placed in the build vat. In use, such LED lights may promote the creation of one or more shadows behind objects that rise above the floor of the build vat and/or the surface of the energy-curable liquid placed in the vat. Such shadows may then be imaged by a camera and used by the error detection system to determine the presence of debris.

In particular embodiments, the size of a shadow may be used to determine the size of a given piece of debris, e.g. to determine the most appropriate debris removal strategy. In other embodiments, the shape of a shadow may be used as input to determine the root cause of an error, or to detect similarities between multiple errors resulting in debris events. Yet other embodiments use the location of a given shadow to determine the location of the debris causing the shadow. In a particular set of embodiments, a movable light—or alternatively multiple fixed lights—allow a profiling of a piece of debris through a circular or spherical sweep or sequential illumination of the debris from multiple angles.

Another subset have one or more LED lights that are disposed about the lens of a camera that is disposed either above or below the build vat. A particularly advantageous embodiment employ one or more LED lights that are disposed below the floor of the build vat and co-act with a camera disposed above the build vat to detect differences in reflection between un-covered parts of the build vat floor and parts of the build vat floor that are covered with debris. An even more advantageous embodiment employs a partially transparent grid or mask (also referred to as contrast element) that is also disposed below the build vat and either above or below at least one of the LED lights and configured to create a pattern of light and dark areas. In some embodiments, the pattern is a raster pattern. Other embodiments employ checkered patterns. In other embodiments, the pattern defines a coordinate system. In particular embodiments, the size of the pattern elements determines the minimum detectable area of an individual piece of debris. A more particular embodiment employs a pattern element size of 0.7 mm. Other embodiments employ pattern element sizes that are matched to the resolution of the upper camera.

In use, such a grid or mask will further enhance the contrast between covered and un-covered sections of build plane floor, and will further promote detection of debris.

Such detection is particularly advantageous, especially when the build material is transparent.

In some embodiments, the additive manufacturing device comprises a debris location system for determining the position of debris in a build vat. Particular embodiments employ a digital camera disposed below the build vat and imaging the bottom of the vat to determine the location of debris. Yet more particular embodiments employ one or more LEDs or similar light sources that are disposed below the build vat—e.g. about the camera lens—to further illuminate the bottom of the build vat.

Such location is advantageous in order to determine if a particular area of a build vat gives rise to a disproportionate amount of debris incidents. Other advantages include the option of selectively solidifying the energy-curable liquid around the debris to promote a removal and/or using disposable means for debris removal more than once in cases where debris is located in different areas of the build vat.

In some embodiments, the debris removal system comprises a debris removal platform. Some embodiments comprise debris removal platforms that are integral with the build platform whereas other embodiments comprise debris removal platforms that are separate from the build platform. Some embodiments comprise debris removal platforms that are configured to co-act with vacuum-assisted build platforms to support automated change between build platforms and debris removal platforms. In some of those embodiments, the debris removal platforms comprise debris removal plates, and the vacuum assisted build platform is configured to establish an operative connection with either a build plate or a debris removal plate.

Particular embodiments have debris removal platforms that comprise debris removal surfaces. In some embodiments, the debris removal surfaces comprises or is comprised by compressible (e.g. spongeous) or deformable material that compresses or deforms when pressed against the debris. Advantageous embodiments of such compressible or deformable material have a compression force in the range of 0-200 N, alternatively in the range 0-7.5 kPa or in the range 0-65 shore A-00. Other compression force ranges may also apply for particular situations. It is particularly advantageously to have a material that easily is compressed or deformed but not elongated or stretched.

Some embodiments comprise compressible or deformable elements that retain their compressive or deformable performance in temperature ranges up to 200 degrees Celsius.

Particular embodiments employ compressible or deformable material in a thickness that may be matched to the dimensions of the largest expected debris size. Some embodiments have thicknesses being 2× the maximum size of expected debris, but other thicknesses may also be desirable.

Other embodiments employ compressible or deformable material having a colour and/or cell structure that is promoting colour contrast to the colour of the build material to be used. A particular embodiment employs a white compressible or deformable material with a closed-cell structure where black or dark build material is used.

Other embodiments employ compressible or deformable material having a smooth and shiny or reflective surface/cell structure (e.g. promoting light reflection) that has a colour and/or surface structure that is providing a relatively high contrast to the colour of the build material to be used.

Some embodiments comprise compressible or deformable material that is configured to cover substantially the entire floor of the build vat or at least a continuous (part) length thereof. Such embodiments are particularly advantageous where void detection based on Canny filtering is used to detect the presence of debris. In such embodiments, the compressible or deformable material will substantially improve signal/noise ratios and resulting detection rates by compressing or deforming against, and thus providing, a uniform coverage of the floor, except where debris prevents the compressible or deformable material from reaching the floor. A particularly advantageous subset of embodiments comprise closed-cell foams with cell sizes of 3 mm or less, and where smaller cell sizes yield better debris detection resolution. Another subset of embodiments comprise open-cell foams with cell sizes of 3 mm or greater.

Other particular embodiments comprise compressible or deformable material that is cut or has openings, etc. in a desirable profile. An advantageous profile that is suitable for the removal of larger pieces of debris comprises a cut-out that covers a central zone and/or one or more columns in one or more corners.

Other embodiments comprise cuts that divide the compressible or deformable material into sections. Such sectioning may be advantageous as it allows sections that are not directly in contact with debris to make full contact with the floor, whereas sections that are in contact with debris will not contact the floor or at least contact the floor less. In some embodiments, cuts are parallel. Other embodiments comprise cuts that intersect to create squares or other geometries. Alternative embodiments include cuts in patterns that may be tailored to suit specific objects.

Other embodiments comprise a cut surface of the compressible or deformable material that is not parallel to the vat floor. A wedge shape is particularly effective to insure easy removal of the cured material. When compressed or deformed on the vat floor, the compressible or deformable material will be compressed or deformed more in one end of the wedge shaped than the other ensuring a predicable delamination on retraction of the compressible or deformable material, as the least compressed or deformed material will peal of the cured material from the vat floor first.

The use of compressible or deformable material is particularly advantageous where debris detection and debris removal is combined. Embodiments comprising this combination will typically conduct a combined debris detection and debris removal routine upon completion of a build process, to prepare the build vat for the next build process, but other timings of this routine are also envisioned.

The use of compressible or deformable material is also advantageous where transparent build materials are used. While detection of transparent debris in transparent material has been enabled by inclusion of the contrast element, it may not be possible to reliably determine the height of the debris based on shadow analysis. Failure to accurately determine the height of a piece of debris that exceeds the size constraints of the compressible or deformable material may lead to damage to the membrane when the compressible or deformable material has been fully compressed or pressed/deformed against the debris, and the descending debris removal platform starts exerting direct pressure on the debris. While fail-safes may be built into the movement mechanism that aborts lowering of a build plane or debris removal plane if excessive resistance is met, a preferred embodiment uses a lower camera (see e.g. 300 in the Figures) to detect a downward flexion of the build vat floor as a change in contrast or reflection. In some embodiments, an additional light source, placed a distance away from the camera, may improve imaging of the changed contrast or reflection and may interrupt the movement mechanism's lowering before damage is sustained by the build vat or the build vat floor.

In use, a debris removal platform with compressible or deformable material may be lowered towards the build vat floor in response to the detection of debris by the debris detection system until a desired lowered position has been achieved. In the areas where the debris is located, the compressible or deformable material will be compressed or deformed and will be prevented from reaching the floor of the build vat. Compression or deformation will result in the application of a slight pressure on the debris, but selection of a compressible or deformable material with an adequate softness will prevent the debris to damage the non-stick foil or membrane. In areas containing no debris, the compressible or deformable material will not be compressed or deformed and will make contact with the floor of the build vat. Once lowering has been completed, energy from the energy source may be applied to solidify the energy-curable liquid surrounding the debris and attach the debris to the compressible or deformable material.

Some embodiments employ solidification of the entire build area, whereas other embodiments employ selective solidification of areas surrounding debris. Such selective solidification may allow debris removal to happen with a reduced consumption of material, and may also allow a compressible or deformable element to be used for more than one debris removal and may be based on information captured by the debris location system. In a particular embodiment of the debris location system, a camera disposed below the build vat may be used to detect the location of debris once the debris removal platform with the compressible or deformable material has been lowered to the desired lowered position above the floor of the build vat. Such detection may comprise detecting differences in reflection and/or colour between areas where the compressible or deformable material has made contact with the floor of the build vat and areas where the compressible or deformable material is held away from the floor of the build vat by the debris. Some embodiments furthermore comprise light sources such as LED light sources that may further assist in the detection of debris by illuminating the bottom of the build vat to increase contrasts.

Yet other embodiments employ compressible or deformable material that is brought against the floor of the build vat in a dry debris removal routine to check the cleanliness or intactness of the membrane before a first build is initiated.

Once debris has been attached to the compressible or deformable material, the debris removal platform may be moved away from the build vat and either discarded or stored for reuse in another debris removal procedure.

To facilitate continuous and automatic operation, some embodiments comprise a platform exchanger that allows a changing between the build platform and the debris removal platform. Some embodiments comprise platform exchangers that are based on standard industrial connectors. A particularly advantageous embodiment comprises an Erowa tool-changer module having a chuck that is mounted on the movement mechanism that enables moving the build platform. The chuck allows for simple engaging and disengaging of the build platform. A chucking spigot mounted on the build platform allows establishing of an operative and interruptible connection between the build platform and the movement mechanism. A similar chucking spigot mounted on a debris removal platform allows establishing of an operative and interruptible connection between the debris removal platform and the movement mechanism.

In use, a build may be initiated by establishing of a first operative connection between the movement mechanism and the build platform followed by a lowering of the build platform towards a first lowered position one layer thickness above the floor of the build vat. A first selective application of energy may either partially or fully solidify a first layer of energy-curable liquid and adhere this first layer to the build platform as generally known, and the build platform may be moved away from the floor of the build vat by the movement mechanism to allow un-cured liquid to flow into the area below the cured layer. If needed, mechanisms such as those disclosed in WO2016177893A1, incorporated into this application in its entirety, may be used to facilitate release of the solidified first layer from the floor of the build vat. Additional layers may be formed by successively repeating the application of energy and the raising of the build platform to build up one or more objects that are attached to the build platform.

If debris is detected, either before, during or after the build procedure, the operative connection between the build platform and the movement mechanism may be interrupted. To support the build platform, with or without partially or fully formed objects, some embodiments comprise a tool holder with a tool fixture or carrier that may receive and hold the build platform when the operative connection with the movement mechanism is interrupted. In a particularly advantageous embodiment, the tool holder is movable from a first disengaged position to a second engaged position where the tool fixture may receive the build platform. In an even more advantageous embodiment, the tool holder also comprises one or more additional tool fixtures or carriers that may hold one or more debris removal platforms, and move at least one of these into a position where they may establish an operative engagement with the movement mechanism. In some embodiments, only the tool holder is movable relative to the movement mechanism, whereas other embodiments comprise movement mechanisms that are also movable relative to the tool holder.

Once an operative connection between the movement mechanism and a debris removal platform has been established, the debris removal platform may be lowered towards the build vat and a debris removal procedure may be carried out as previously disclosed.

In some embodiments, the build platform and the debris removal platform are combined into a single platform. Some of these embodiments comprise an interface element that allows an exchange between a build plate with a build surface and a debris removal plate with a debris removal surface that may in some embodiments be a compressible or deformable element. In a particular set of embodiments, this interface element comprises a vacuum suction unit. Other embodiments employ interface elements comprising industrial connector systems, click fits, magnets, grooves, rails, or similar.

A vacuum-assisted debris removal platform or plate that is particularly advantageous for the removal of large debris—or for repeated applications without need for replacement—comprises a vacuum suction element that is configured to establish an operative and interruptible connection with the surface of a solidified layer of energy-curable liquid. In use, a piece of debris is detected by means of the debris detection system, and solidification of the liquid surrounding the debris creates a solidified handling plate, handling layer, or handling area (forth simply referred to as handling plate) containing the debris. The area of this solidified handling plate, etc. may either comprise the entire build area (layer) or a smaller handle section that allows removal of the debris. Before, during, or after solidification, the build platform may be exchanged with the vacuum-assisted debris removal platform or plate by means of the platform exchanger or interface element disclosed above. The vacuum-assisted debris removal platform or plate may subsequently be lowered to a point where the vacuum suction element may establish a vacuum-assisted operative connection with a corner-most section of the handling plate or the handle section holding the debris. A subsequent raising of the vacuum-assisted debris removal platform will allow the handling plate or the handle section comprising the debris to be removed from the build vat.

In some embodiments, a light emitting probe with a replaceable light permeable tip may be inserted into the vat where, when the probe is placed in the proximity of a piece of debris, it is set to emit light thereby curing the debris or a solidified handling plate capturing the debris to the tip. After, the tip may be raised out of the vat removing the debris with it.

While some embodiments employ debris removal during the build process, other embodiments employ debris removal either before a build has been started or after it has been completed.

In some embodiments, the additive manufacturing device comprises a material recovery system for removing uncontaminated build material from a build vat prior to debris removal.

Some embodiments of the additive manufacturing device comprise data storage elements configured to receive the data from the one or more cameras, and to store this data for real-time or post-process analysis. A particular subset of embodiments comprise data processing elements that may be configured to perform analyses on the data with the aim of identifying patterns and supporting the development of strategies for minimizing the risk of debris occurrence. A particularly advantageous subset of embodiments comprise machine learning elements, artificial intelligence elements or similar elements and are configured to support predictive modelling and analysis of potential failure modes.

In some embodiments, a drip tray for minimizing resin drips in the vat is provided that otherwise could cause air bubbles in the build vat, which could lead to false spot detection.

In some embodiments, the debris elimination system comprises a compressible or deformable material configured to compress or deform when pressed against debris located in the at least one build material in the build vat.

In some embodiments, the additive manufacturing device is configured to move the compressible or deformable material through the at least one build material, when contained in the build vat, towards and/or to the floor of the build vat thereby pushing debris towards and/or to the floor of the build vat.

In some embodiments, the compressible or deformable material
comprises a number of interspaced cavities or similar defining separate sections of compressible or deformable material, and/or
has a colour having a relatively high contrast with a colour of the at least one build material.

In some embodiments, the additive manufacturing device is configured to solidify the build material surrounding the debris so that the debris is connected or attached to the compressible or deformable material once the compressible or deformable material has been moved towards or onto the floor of the build vat. Some embodiments employ solidification of the entire build area/layer, whereas other embodiments employ selective solidification of areas surrounding only the debris.

In some embodiments, the debris detection system comprises
a first camera or imaging device located below the build vat and being configured to capture images through the floor of the build vat and/or
a second camera or imaging device located above the build vat and being configured to capture images of an upper surface of the floor of the build vat and/or a surface of the at least one build material from above, when the at least one build material is contained in the build vat.

In some embodiments, one or more captured images is/are processed and analysed to determine whether debris is present in the build vat or not.

In some embodiments, the additive manufacturing device is configured to selectively solidify at least a part of the at least one build material around or at debris detected in the build vat to promote a removal of the debris.

In some embodiments, the additive manufacturing device comprises
one or more light sources configured to illuminate a bottom part or an underside of the build vat from below, and/or
one or more light sources configured to illuminate an upper surface of the floor of the build vat and/or a surface of the at least one build material from above, when the at least one build material is contained in the build vat from above.

In some embodiments, the at least one build material is transparent or translucent and wherein the additive manufacturing device further comprises a transparent or translucent contrast element located below the build vat and being configured to create a pattern of light and dark areas through the floor of the build vat when being illuminated by one or more light sources from below and/or above.

In some embodiments, the floor of the build vat is optically transparent or translucent.

In some embodiments, the floor of the build vat is energy-transparent in relation to the energy source.

In some embodiments (e.g. where the additive manufacturing device further comprises a transparent or translucent contrast element located below the build vat), the additive manufacturing device comprises a (first) camera or imaging device located below the build vat and being configured to capture images, from below, of a surface of the floor of the build vat and/or a surface of the at least one build material when the at least one build material is contained in the build vat, and wherein the floor of the build vat is deformable and the (first) camera or imaging device is configured to capture one or more images of the floor of the build vat when the floor is deformed by a layer release mechanism to release at least a part of a manufactured object.

In some embodiments, the floor of the build vat is flexible and the additive manufacturing device comprises a layer release mechanism configured to release, by gradual and controlled peeling, a lastly formed layer of a manufactured object from the flexible floor, and wherein a camera (e.g. a lower camera as disclosed herein) is configured to capture a peeling pattern comprising presence or absence of gradual changes in contrast and/or color in areas where release is being achieved, has been achieved, or has partially or fully failed to be achieved.

In some embodiments, the floor of the build vat is flexible e.g. according to one of the embodiments as disclosed in WO2016177893A1 that is incorporated herein in its entirety. WO2016177893A1 also discloses embodiments of particularly advantageous layer release mechanisms.

In some embodiments, data representing the captured peeling pattern is compared to an expected or previously captured peeling pattern and analysed to determine whether a release failure has taken place or potentially has taken place.

### Definitions

All headings and sub-headings are used herein for convenience only and should not be constructed as limiting the invention in any way.

The use of any and all examples, or exemplary language provided herein, is intended merely to better illuminate the invention and does not pose a limitation on the scope of the invention unless otherwise claimed. No language in the specification should be construed as indicating any non-claimed element as essential to the practice of the invention.

This invention includes all modifications and equivalents of the subject matter recited in the claims appended hereto as permitted by applicable law.

### BRIEF DESCRIPTION OF THE DRAWINGS

FIG. 1 schematically illustrates an embodiment of an additive manufacturing system with automated failure recovery according to an aspect of the present invention;

FIGS. 2a-2c schematically illustrate different exemplary operating steps or stages of the embodiment of FIG. 1;

FIG. 3 schematically illustrates an exemplary embodiment of a debris removal platform;

FIG. 4 schematically illustrates another exemplary embodiment of a debris removal platform;

FIG. 5 schematically illustrates another exemplary embodiment of a debris removal platform;

FIG. 6 schematically illustrates another embodiment of an additive manufacturing system with automated failure recovery;

FIGS. 7a and 7b schematically illustrate a side view and a top view, respectively, of the system of FIG. 6;

FIGS. 8a and 8b schematically illustrate a side view and a detailed view of a layer release mechanism releasing an additively manufactured object from a flexible floor of a vat; and

FIGS. 9a-9d schematically illustrate a reference release pattern and different exemplary release patterns.

### DETAILED DESCRIPTION

Various aspects and embodiments of an additive manufacturing device and system and debris removal systems for the same will now be described with reference to the figures.

When/if relative expressions such as “upper” and “lower”, “right” and “left”, “horizontal” and “vertical”, “clockwise” and “counter clockwise” or similar are used in the following terms, these typically refer to the appended figures and not necessarily to an actual situation of use. The shown figures are schematic representations for which reason the configuration of the different structures as well as their relative dimensions are intended to serve illustrative purposes only.

Some of the different components are only disclosed in relation to a single embodiment of the invention, but are meant to be included in the other embodiments without further explanation.

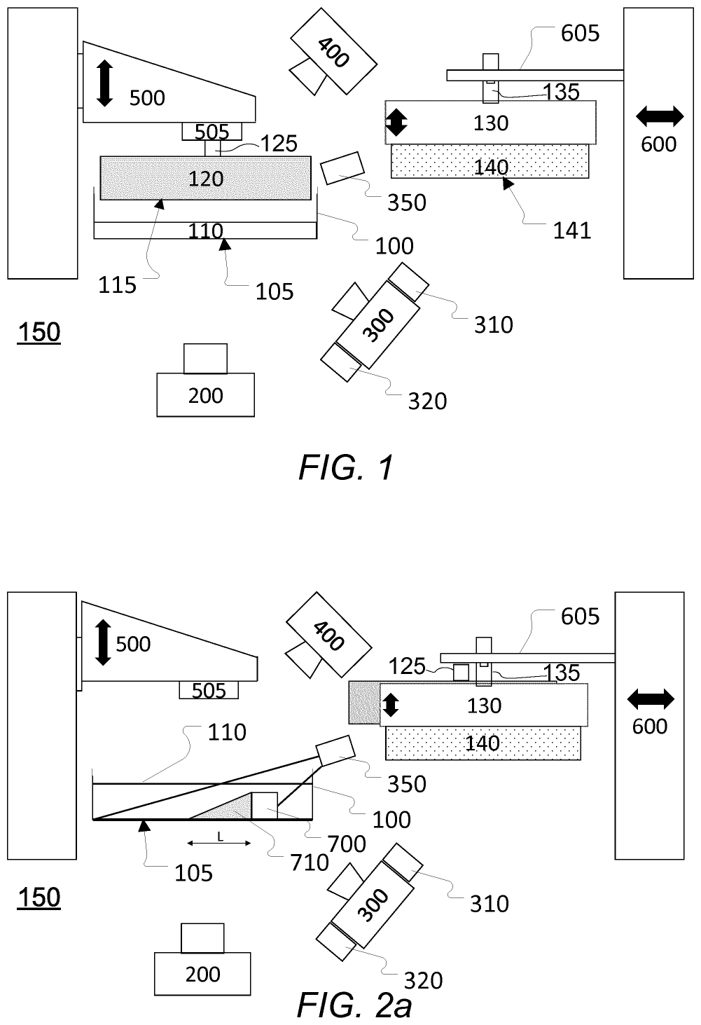

FIG. 1 schematically illustrates an embodiment of an additive manufacturing system with automated failure recovery according to an aspect of the present invention.

Illustrated is an embodiment of an additive manufacturing system with automated failure recovery comprising an additive manufacturing device 150 comprising a build vat 100 containing, during use, an energy-curable liquid 110 (also referred to as build material throughout this specification). The build vat 100 has a floor 105. In at least some embodiments, the floor 105 of the build vat 100 is optically transparent or translucent. An energy source 200 is disposed below the build vat 100 and configured to selectively solidify the energy-curable liquid 110 as generally known. A build platform 120, comprising in at least some embodiments and as shown, an Erowa spigot 125 or other suitable connector, is movably held above the build vat by an movement mechanism 500 or similar comprising a mating Erowa chuck 505 or other suitable mating connector.

A lower camera (also denoted first camera) 300 is, in this and similar embodiments, disposed below the build vat 100 and configured to capture images through the optically transparent or translucent floor 105 of the build vat 100. In at least some embodiments and as shown, the lower camera 300 comprises one or more LEDs, here two LEDs 310 and 320, or other suitable light sources e.g. as disclosed herein, that are configured to illuminate the bottom or underside of the build vat 100 from below to facilitate image capture. In at least some embodiments and as shown, an LED 350 is disposed at, in the vicinity, or adjacent to a rim of build vat 100 and is configured to illuminate an upper surface of the build vat floor 105 and/or the surface of the energy-curable liquid 110 from above. An upper camera 400 is disposed above build vat 100 and is configured to capture images of the upper surface of the build vat floor 105 and/or the surface of the energy-curable liquid 110 from above.

The embodiment of an additive manufacturing system with automated failure recovery illustrated in FIG. 1 further comprises an embodiment of a debris removal platform 130 according to an aspect of the present invention. The debris removal platform 130 comprises one or more debris removal surfaces 141 comprising, at least in some embodiments, compressible or deformable material 140 as disclosed herein. In some embodiments and as shown, the debris removal platform 130 is movably held by a tool fixture 605 or the like that is part of or secured to a tool holder 600 or the like. The debris removal platform 130 comprises, in at least some embodiments and as shown, an Erowa spigot 125 or other suitable connector mating with an Erowa chuck 505 or other suitably mating connector of the tool fixture 605.

The additive manufacturing device 150 is preferably a bottom-up projection device but the methods and devices disclosed herein may also be adapted for failure management in e.g. a top-projection based 3D printer system, a bottom-projection based 3D printer system, another type of 3D printing system, a laser sintering system, a protrusion system, an extrusion-based 3D printer system, a 3D bio-printing or bio-plotting system, a fused deposition modelling (FDM) system, or any other suitable additive manufacturing system.

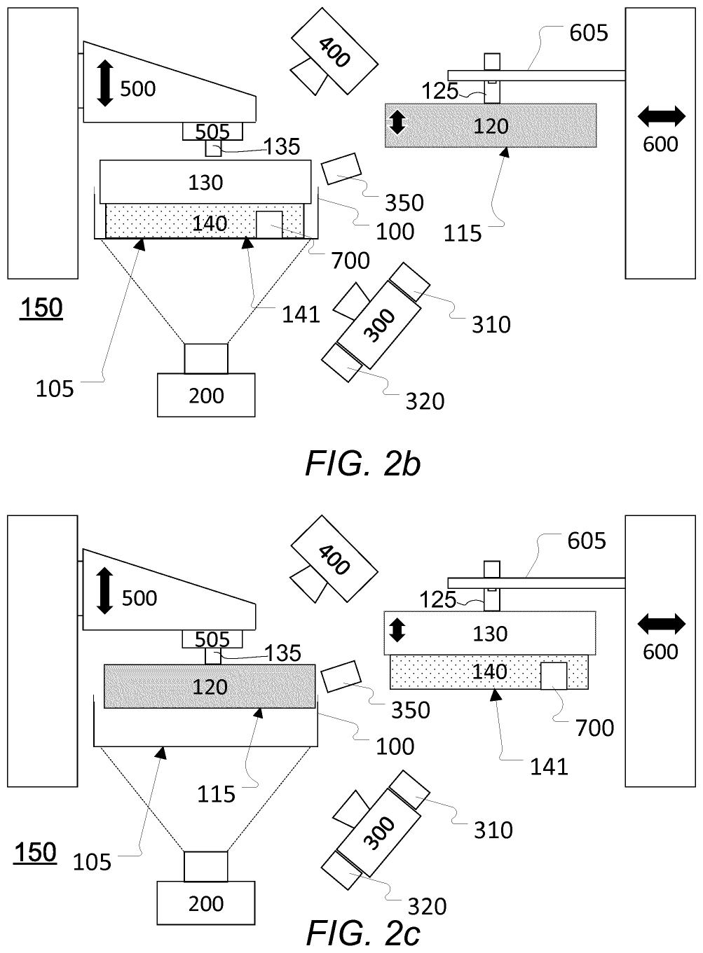

FIGS. 2a-2c schematically illustrate different exemplary operating steps or stages of the embodiment of FIG. 1.

Shown is an exemplary embodiment of an additive manufacturing system with automated failure recovery corresponding to the one shown in FIG. 1 (e.g. with further details). It is to be understood that the operating steps or operating stages as described in connection with FIGS. 2a-2c may also be used correspondingly for other embodiments of an additive manufacturing system with automated failure recovery as disclosed herein.

In some embodiments and as shown in FIGS. 2a-2c, the build vat 100 comprises an energy-transparent (energy-transparent for the energy source 200) floor 105 comprising, at least in some embodiments, an energy-transparent ‘non-stick’ membrane (not shown). In at least some embodiments, the floor 105 is optically transparent or translucent. The build vat 100 contains, at least during use, an energy-curable liquid 110 that may be selectively solidified by energy that passes through the floor 105 and the membrane.

As mentioned, the build platform 120 is movably held above the build vat 100 by movement mechanism 500 or similar e.g. by means of an Erowa chuck 505 that is operatively connected to an Erowa chucking spigot 125.

The build platform 120 comprises a build surface 115 for holding or supporting, during use, at least one object (not shown) being manufactured by an additive manufacturing process according to the additive manufacturing device 150. For additive manufacturing processes, the object(s) may e.g. be manufactured using one or several energy- and/or light-sources.

During a building process, a first new layer is formed when energy-curable liquid on the floor of the vat (i.e. inside the vat) is exposed to energy from one or more suitable energy sources 200. In some embodiments, the energy source 200 is a DLP or LCD projector or similar and the energy is supplied in the form of UV light. The pattern or geometry of the new layer may e.g. be defined by a product definition file, a template or mask, etc. as generally known.

Following exposure, the build platform 120 is raised a distance away from the floor 105 of the build vat 100. Raising is done to allow a new quantity of energy-curable liquid 110 to flow into the area below the build platform 120 and the newly formed layer. If required, a layer release mechanism (not shown) e.g. such as the mechanism disclosed in WO2016177893A1 may be used to facilitate layer release.

Once a new quantity of energy-curable liquid 110 has filled the area below the build platform 120 and the newly formed layer, the build platform 120 may be repositioned and exposure may be repeated to solidify a further layer, The process may then be repeated a specified number of times to create one or more objects.

As mentioned, debris (see e.g. 700 in FIGS. 2a-2c) may result from the building process. Alternatively, it may be induced into the build vat from the exterior of the additive manufacturing device. Such debris is detected by either camera 300 or camera 400 as disclosed herein either before, during, or after the additive manufacturing process and may trigger a debris removal process as disclosed herein.

As mentioned, FIGS. 2a-2c schematically illustrate different exemplary operating steps or stages of the embodiment of FIG. 1.

An exemplary operating step or stage according to one embodiment of the debris removal process is illustrated in FIG. 2a and comprises an initial raising or movement of build platform 120 to a raised or removed position. In the raised or removed position, the Erowa chucking spigot 125 or similar may be engaged by a tool fixture (not shown) or in another way and the build platform 120 is disconnected from the Erowa chuck 505 or similar of the movement mechanism 500. The build platform 120 may be parked appropriately, e.g. at the tool holder 600 or the like (as shown, being behind the debris removal platform 130).

While (or after) disconnect is performed, the LED 350 illuminates the surface of energy-curable liquid 110 and/or the floor 105 of the build vat 100 producing for each piece of debris 700 a corresponding shadow 710. One or more images of this shadow 710 for each piece of debris 700 may then be captured by the upper camera 400 and may be analysed by a processing device such as a computer or the like to calculate or estimate a height of each piece of debris 700. The height may e.g. be determined or estimated based on the length L of the shadow 710 projected on the floor 105 of the build vat 100. Alternatively or in addition, one or more other characteristics of the shadow 710 and/or the piece of debris 700 may be derived. Provided that no detected piece of debris 700 exceeds a predetermined height limit (or other type limit or criteria)—preferably determined or imposed in relation to one or more characteristics of the compressible or deformable material 140 of the debris removal platform 130, and following disconnect of build platform 120, the debris removal platform 130 is moved into a connecting position by tool holder 600 and chucking spigot 135 or the like of the debris removal platform 130 is then connected to the Erowa chuck 505 or the like of the movement mechanism 500. It is to be noted, that the size of the debris 700 is exaggerated for clarity in the Figures.

Depending on the situation, the vat 100 may e.g. be drained or emptied of the energy-curable liquid 110 or the energy-curable liquid 110 may still be in the vat 100 (as illustrated; the energy-curable liquid 110 is shown not filled out for clarity's sake).

Subsequently, the debris removal platform 130 is lowered to a lowered position where the portions of the compressible or deformable material 140 that are not suspended by debris 700 are brought in contact with the floor 105 of the vat 100 as is illustrated in FIG. 2b. The lower camera 300 e.g. comprising LED's 310 and 320 may then readily and reliably be used to identify respective locations of debris 700 manifesting as differences in reflection and/or contrast when held against the uniform background defined by the compressible or deformable material. Moving the debris removal platform in this form will push any pieces of debris towards the floor 105 of the build vat 100 while the compressible or deformable material will absorb (and/or displace) a part of the energy-curable liquid 110 of the vat 100, if any is present.

When locations of debris 700 readily have been identified by image analysis on one or more images obtained by the lower camera 300, energy from energy source 200 can then be applied to solidify either a part of or the entire energy-curable liquid 110 surrounding or near the respective pieces of debris 700 to cause an attachment of the solidified liquid to the compressible or deformable material 140 thereby fixating the respective pieces of debris 700 to the compressible or deformable material 140. The debris removal platform 130 may then subsequently be raised to the raised position bringing fixated pieces of debris 700 along with it and replaced with the build platform by means of tool holder 600 as shown in FIG. 2c. This effectively removes debris 700 from the vat 100.

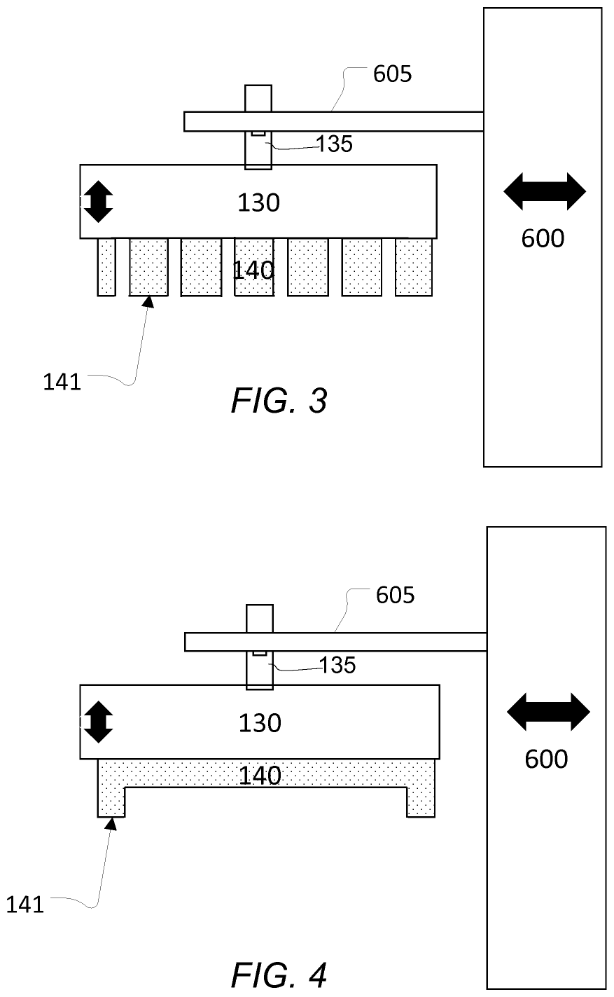

The debris removal platform 130 may comprise various embodiments of compressible or deformable material 140 as disclosed herein where some exemplary ones are shown and explained further in connection with FIGS. 3-5.

FIG. 3 schematically illustrates an exemplary embodiment of a debris removal platform.

Illustrated is one embodiment of a debris removal platform 130 comprising a compressible or deformable material 140 as disclosed herein. In this particular embodiment, the compressible or deformable material 140 comprises a number (in this example six) of vertical (in the orientation of the Figure) interspaced cuts/cutouts, cavities, spaces, etc. defining a number of separate sections of compressible or deformable material 140 each section having a removal surface 141 (in this example seven separate removal surfaces 141). It is noted, that the sections do not need to be fully separated. The cutout, etc. may e.g. be a half-circle, etc. or in general any other suitable shape or geometry.

An advantage of such a sectioning is e.g. that sections that capture a piece of debris will not make full contact with the floor of the vat—or at least make less fully contact—specifically due to the presence of debris while sections not capturing any debris will make full contact with the floor of the vat. Such a difference in contact between sections with and without contact facilities the subsequent image analysis.

The debris removal platform 130 is shown, as an example, secured to a tool fixture 605 or the like that is part of or secured to a tool holder 600 or the like via a chucking spigot 135 or the like.

FIG. 4 schematically illustrates another exemplary embodiment of a debris removal platform.

Illustrated is another exemplary embodiment of a debris removal platform 130 comprising a compressible or deformable material 140 as disclosed herein where the compressible or deformable material 140 comprises an elongated (generally in the horizontal direction) central single cut-out defining two sections respectively located to the far left and far right and each having a debris removal surface 141.

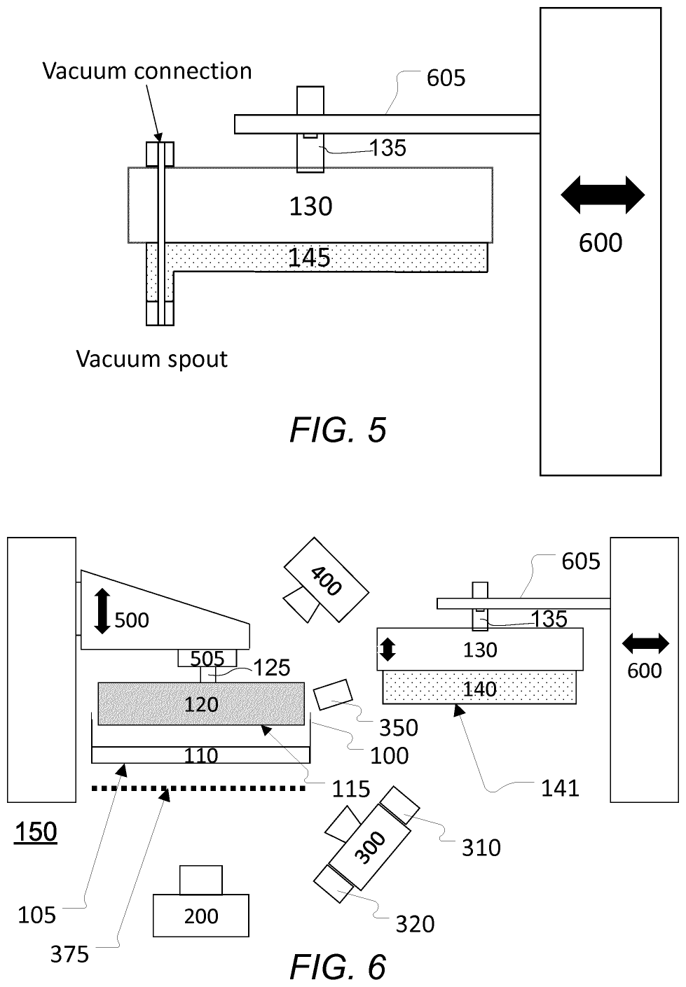

FIG. 5 schematically illustrates another exemplary embodiment of a debris removal platform.

Illustrated is another exemplary embodiment of a debris removal platform 130 comprising a compressible or deformable material as disclosed herein. In this exemplary embodiment, the debris removal platform 130 and the compressible or deformable material comprises a vacuum suction element 145 particularly suited for removal of relatively large debris and/or for repeated applications without need for replacement of the compressible or deformable material.

The vacuum suction element 145 is configured to establish an operative and interruptible connection with a surface of a solidified layer of energy-curable liquid. In use, a piece of debris is e.g. detected as disclosed herein and solidification of the liquid surrounding the debris creates a ‘handling plate’ containing the debris. The area of this solidified plate may either comprise the entire build area or a smaller handle section that allows removal of the debris. In other words, the liquid is solidified surrounding the debris and liquid is solidified along a path from the debris to a location where the vacuum suction element 145 can make a connection with the solidified liquid. This enables only a minimum amount of liquid is solidified—and thereby wasted—for removing the debris.

As mentioned, other shapes/geometries/layouts, etc. of the compressible or deformable material 140 may be envisaged including e.g. such as disclosed herein or other. One example is e.g. a wedge shape as disclosed herein.

FIG. 6 schematically illustrates another embodiment of an additive manufacturing system with automated failure recovery. The exemplary embodiment of FIG. 6 corresponds to the one shown in FIG. 1 but with the addition of a contrast element 375 as disclosed herein located below the floor 105 of the build vat 100 and above the energy source 200 and above the at least one of light source 310, 320.

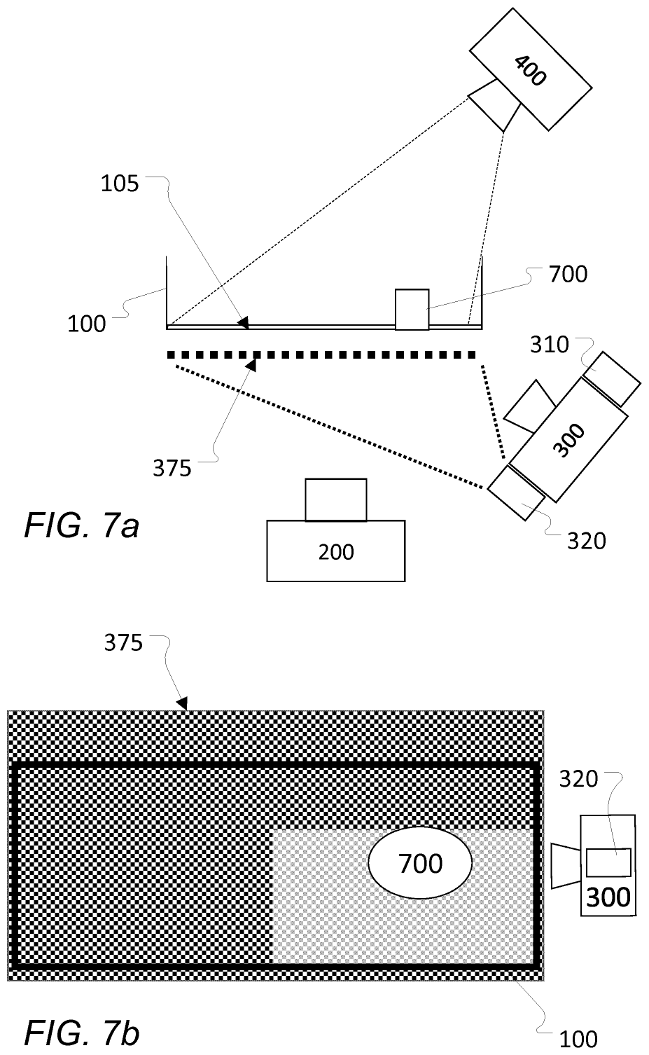

As disclosed herein, the inclusion of a contrast element 375 is at least in some embodiments particularly useful when a transparent or translucent building material 110 is used. In some embodiments, the contrast element 375 comprises a translucent plate or similar having a checkered pattern (see e.g. 375 in FIG. 7b) covering at its upper surface (the surface closest to the floor 105 of the vat 100). In at least some embodiments, the translucent plate is movable between a first unengaged position outside the field of vision of the energy source 200 and a second engaged position where the contrast element 375 is positioned below the build vat. Movement of the contrast element 130 may either be manual or automated.

When in the engaged position, the contrast element 375 may be illuminated from below by the at least one LED 310, 320 or other suitable light source that is disposed below the contrast element. Illumination in this way will increase the contrast ratio between the light and dark elements in the checkered pattern and will facilitate detection of differences in diffraction between the area covered by the debris 700 and non-covered areas as illustrated in FIG. 7b. Such differences may be imaged by upper camera 400 to detect the presence and position of debris 700 as illustrated in FIG. 7a.

FIGS. 7a and 7b schematically illustrate a side view and a top view, respectively, of the system of FIG. 6

FIG. 7a shows a side view of the contrast element 375 that is illuminated from below by an LED 320 or other suitable light source. Further illustrated is a vat 100 containing a transparent build material and a piece of debris 700.

FIG. 7b shows a top view of the contrast element 130, above which is placed a vat 100 with a piece of debris 700. Shown is also the contrast between the transparent build material and the debris 700 that allows reliable detection of the debris.

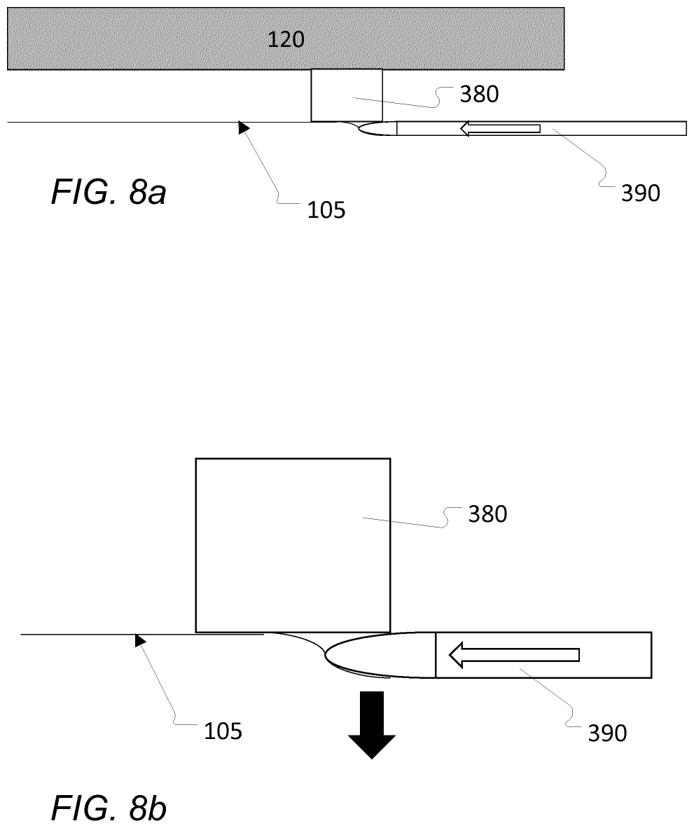

FIGS. 8a and 8b schematically illustrate a side view and a detailed view of a layer release mechanism releasing an additively manufactured object from a flexible floor of a vat.

Schematically illustrated in FIG. 8a is a layer release mechanism 390 releasing a manufactured object 380 (more specifically releasing a lastly formed layer of the manufacture object 380) from a flexible floor 105 of a vat (not shown) as disclosed herein. The manufactured object 380 is shown attached to a build platform 120.

In some embodiments and as shown, the layer release mechanism employs a build vat floor deformation mechanism or deformer 390 to generate a wave or slope that travels along the length of the floor of the build vat and effects a controlled and repeatable release of the additively manufactured objects 380 from the build vat floor 390 by peeling the floor away from the additively manufactured objects.

Accordingly, this peeling happens in a controlled and gradual motion and may be imaged by a lower camera (see e.g. 300 in other figures) as a peeling pattern comprising gradual change in contrast or color in those areas where release has been achieved. A systematic monitoring of peeling pattern deviations e.g. from a reference pattern may support failure mode detection and continuous improvements.

In some embodiments, an analysis of layer release patterns (as obtained by a camera) is used to reduce or eliminate the formation of debris.

This whole process, including the change between build platform and debris removal platform, may be automated fully or partly. The whole process or parts thereof may also be carried out manually or semi-manually.

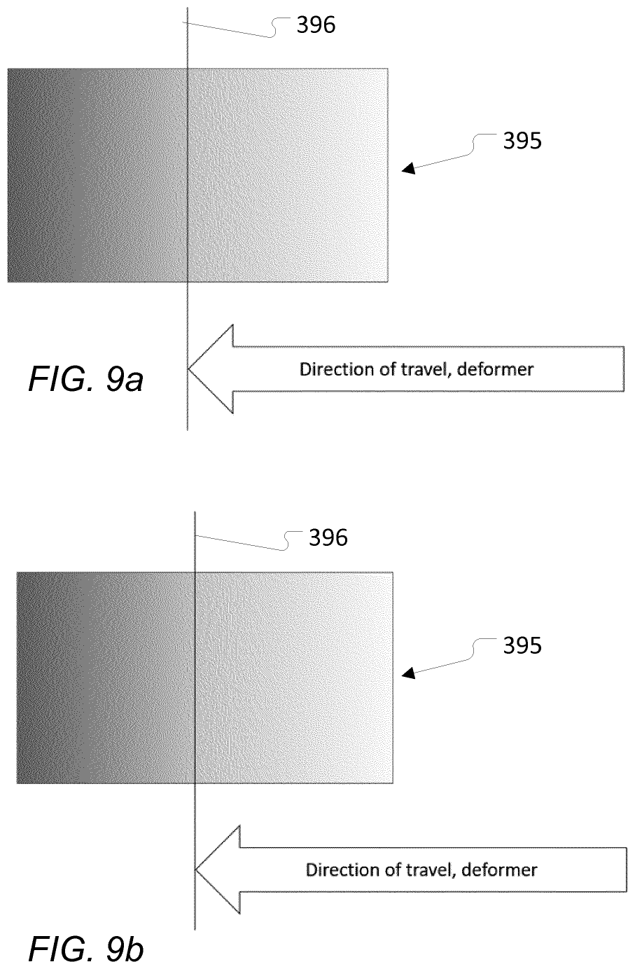

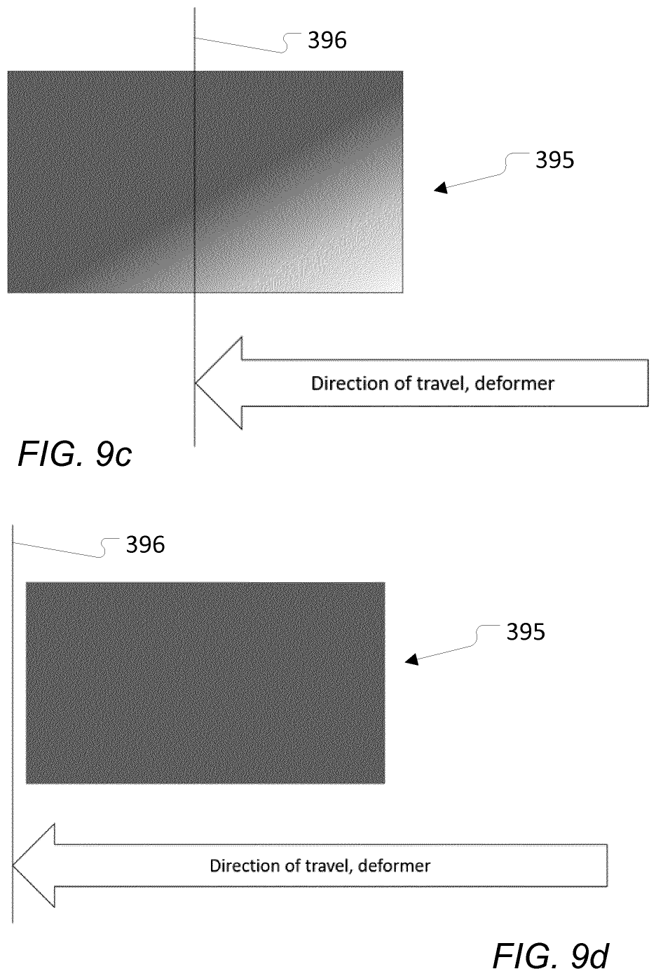

FIGS. 9a-9d schematically illustrate a reference release pattern and different exemplary release patterns.

Shown in FIG. 9a is a reference release pattern 395, shown together with a line 396 indicating an end of the deformer or layer release mechanism and an arrow indicating a direction of travel of the deformer or layer release mechanism.

FIG. 9b illustrates an example of a release pattern 395 caused by incorrect (too hard) illumination/energy exposure resulting in excessive adhesion and delayed release. As can be seen this pattern is different from the reference pattern of FIG. 9a so image analysis can signal a failure and also identify the cause of the failure.

FIG. 9c illustrates an example of a release pattern caused by a defective membrane resulting in excessive adhesion along one side. Again an obtained image of the pattern may be used to indicate that a failure has taken place and potentially the cause.

FIG. 9d illustrates an example of a release pattern indicating a complete detachment of (a part of) object that—despite use of the layer release mechanism—remains attached to or ‘standing on’ the build vat floor e.g. due to breaking of or unintentionally being released from the build plane.

It should generally be noted, that the elements shown in the various figures and described herein do not need to move as indicated by the arrows and different elements may be moved differently as the individual elements may not necessarily need to be handled and/or processed by the same equipment.

It should be noted, that further equipment may be used than the shown ones and one or more of the shown equipment may be omitted based on a given use. The ordering of the equipment may also be changed.

Some preferred embodiments have been shown in the foregoing, but it should be stressed that the invention is not limited to these, but may be embodied in other ways within the subject matter defined in the following claims.

In the claims enumerating several features, some or all of these features may be embodied by one and the same element, component or item. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, elements, steps or components but does not preclude the presence or addition of one or more other features, elements, steps, components or groups thereof.

1. An additive manufacturing device for additively manufacturing objects, wherein the additive manufacturing device comprises
a build vat having a floor and configured to receive at least one build material,
a build platform having a build surface for holding and/or
supporting at least one object being or having been additively manufactured,
a movement mechanism enabling moving the build platform into and out of the build vat,
an energy source configured to provide energy to selectively solidify at least a part of the at least one build material when contained in the build vat, and
a debris elimination system for removing debris from the build vat the debris elimination system comprising
a debris removal system configured to remove detected debris from the build vat.

2. The additive manufacturing device according to claim 1, wherein the additive manufacturing device further comprises a debris detection system configured to detect a presence of debris in the build vat.

3. The additive manufacturing device according to claim 1, wherein the debris elimination system comprises a compressible or deformable material configured to compress or deform when pressed against debris located in the at least one build material in the build vat.

4. The additive manufacturing device according to claim 3, wherein the additive manufacturing device is configured to move the compressible or deformable material through the at least one build material, when contained in the build vat, towards and/or to the floor of the build vat thereby pushing debris towards and/or to the floor of the build vat.

5. The additive manufacturing device according to claim 4, wherein the compressible or deformable material
comprises a number of interspaced cavities or similar defining separate sections of compressible or deformable material, and/or
has a colour having a relatively high contrast with a colour of the at least one build material.

6. The additive manufacturing device according to claim 4, wherein the additive manufacturing device is configured to solidify the build material surrounding the debris so that the debris is connected to the compressible or deformable material once the compressible or deformable material has been moved towards or onto the floor of the build vat.

7. The additive manufacturing device according to claim 2, wherein the debris detection system comprises
a first camera or imaging device located below the build vat and being configured to capture images through the floor of the build vat from below, and/or
a second camera or imaging device located above the build vat and being configured to capture images, from above, of an upper surface of the floor of the build vat and/or a surface of the at least one build material when the at least one build material is contained in the build vat.

8. The additive manufacturing device according to claim 7, wherein one or more captured images is/are processed and analysed to determine whether debris is present in the build vat or not.

9. The additive manufacturing device according to claim 1, wherein the additive manufacturing device is configured to selectively solidify at least a part of the at least one build material around or at debris detected in the build vat to promote a removal of the debris.

10. The additive manufacturing device according to claim 1, wherein the additive manufacturing device comprises
one or more light sources configured to illuminate a bottom part or an underside of the build vat from below, and/or
one or more light sources configured to illuminate, from above, an upper surface of the floor of the build vat and/or a surface of the at least one build material when the at least one build material is contained in the build vat from above.

11. The additive manufacturing device according to claim 1, wherein the at least one build material is transparent or translucent and wherein the additive manufacturing device further comprises a transparent or translucent contrast element located below the build vat and being configured to create a pattern of light and dark areas through the floor of the build vat when being illuminated by one or more light sources from below and/or above.

12. The additive manufacturing device according to claim 1, wherein the floor of the build vat is optically transparent or translucent.

13. The additive manufacturing device according to claim 1, wherein the floor of the build vat is energy-transparent in relation to the energy source.

14. The additive manufacturing device according to claim 1, wherein the additive manufacturing device comprises a first camera or imaging device located below the build vat and being configured to capture images, from below, of a surface of the floor of the build vat and/or a surface of the at least one build material when the at least one build material is contained in the build vat, and wherein the floor of the build vat is deformable and the first camera or imaging device is configured to capture one or more images of the floor of the build vat when the floor is deformed by a layer release mechanism to release at least a part of a manufactured object.

15. The additive manufacturing device according to claim 1, wherein the floor of the build vat is flexible and the additive manufacturing device comprises a layer release mechanism configured to release, by gradual and controlled peeling, a lastly formed layer of a manufactured object from the flexible floor, and wherein a camera is configured to capture a peeling pattern comprising presence or absence of gradual changes in contrast and/or color in areas where release is being achieved, has been achieved, or has partially or fully failed to be achieved.

16. The additive manufacturing device according to claim 15, wherein data representing the captured peeling pattern is compared to an expected or previously captured peeling pattern and analysed to determine whether a release failure has taken place or potentially has taken place.

17. The additive manufacturing device according to claim 3, wherein the debris detection system comprises
a first camera or imaging device located below the build vat and being configured to capture images through the floor of the build vat from below, and/or
a second camera or imaging device located above the build vat and being configured to capture images, from above, of an upper surface of the floor of the build vat and/or a surface of the at least one build material when the at least one build material is contained in the build vat.

18. The additive manufacturing device according to claim 2, wherein the additive manufacturing device comprises a first camera or imaging device located below the build vat and being configured to capture images, from below, of a surface of the floor of the build vat and/or a surface of the at least one build material when the at least one build material is contained in the build vat, and wherein the floor of the build vat is deformable and the first camera or imaging device is configured to capture one or more images of the floor of the build vat when the floor is deformed by a layer release mechanism to release at least a part of a manufactured object.

19. The additive manufacturing device according to claim 2, wherein the floor of the build vat is flexible and the additive manufacturing device comprises a layer release mechanism configured to release, by gradual and controlled peeling, a lastly formed layer of a manufactured object from the flexible floor, and wherein a camera is configured to capture a peeling pattern comprising presence or absence of gradual changes in contrast and/or color in areas where release is being achieved, has been achieved, or has partially or fully failed to be achieved.

20. The additive manufacturing device according to claim 3, wherein the floor of the build vat is flexible and the additive manufacturing device comprises a layer release mechanism configured to release, by gradual and controlled peeling, a lastly formed layer of a manufactured object from the flexible floor, and wherein a camera is configured to capture a peeling pattern comprising presence or absence of gradual changes in contrast and/or color in areas where release is being achieved, has been achieved, or has partially or fully failed to be achieved.
